(19) United States
(12) Patent Application Publication
(10) Pub. No.: US 2025/0074150 A1
(43) Pub. Date: Mar. 6, 2025

(54) METHOD AND SYSTEM FOR HEATING CABINS OF WORK MACHINES

(71) Applicant: Caterpillar Underground Mining Pty. Ltd., South Burnie (AU)

(72) Inventors: Sivakumar Ramasamy, Pugalur Karur (IN); Neeraj Vijayan, Kannur (IN); Sean Robert Saward, Penguin (AU); Hayley Bellinger, Emu Heights (AU)

(73) Assignee: Caterpillar Underground Mining Pty. Ltd., South Burnie (AU)

(21) Appl. No.: 18/814,739

(22) Filed: Aug. 26, 2024

(30) Foreign Application Priority Data
Aug. 31, 2023 (AU) 2023222914

(51) Int. Cl. B60H 1/22; B62D 33/06

(52) U.S. Cl. CPC B60H 1/22; B62D 33/06; B60H 2001/2271

(57) ABSTRACT

A method, for providing supplementary heat energy into a cabin of a work machine when a main heating system of the cabin is inactive, includes using an auxiliary heat source to impart heat to an auxiliary coolant stream. The main energy form powers a main heat source of the main heating system. Further, the method includes providing an auxiliary fluid circuit to fluidly couple the auxiliary heat source with one or more heat exchangers to supply the auxiliary coolant stream from the auxiliary heat source to the one or more heat exchangers for circulation therewithin. During the circulation of the auxiliary coolant stream within the one or more heat exchangers, the auxiliary coolant stream dissipates heat to an air flowing across the one or more heat exchangers and into the cabin to provide the supplementary heat energy into the cabin.

### TECHNICAL FIELD

The present disclosure relates to Heating, Ventilation, and Cooling (HVAC) systems for work machines. More particularly, the present disclosure relates to a system for heating an operator cabin of a work machine.

### BACKGROUND

Heating, Ventilation, and Cooling (HVAC) systems are commonly employed to provide comfortable and controlled environments for operators (e.g., warm temperature in cold climates) within cabins of work machines, such as mining trucks, shovels, and the like. In an exemplary operation of a conventional HVAC system, hot coolant from an engine of the work machine is routed through a heat exchanger of the conventional HVAC system. As the hot coolant is routed through the heat exchanger, the hot coolant dissipates heat to air blowing through the heat exchanger. The heated air is then directed into the cabin, for example, to heat the cabin.

Because the conventional HVAC systems typically rely on the hot coolant supply from the engine, these conventional HVAC systems may be ineffective in situations where the engine is inactive, such as when the machine is stationary to receive a payload. Moreover, a response time of HVAC systems for warming up the cabin may be long, e.g., during a cold start condition of the engine in which the coolant may take time to reach its operating temperature upon the start of the engine.

U.S. Pat. No. 6,874,695 discloses a work machine. The work machine includes an engine, an operator station, a heating system, and an operator heat controller. The heating system includes an electrically-powered coolant pump, a power source, and at least one piece of warmed machinery. The operator heat controller is moveable between a first and a second position, and is operable to connect the electrically-powered coolant pump to the power source when the engine is inactive and the operator heat controller is in the first position. Thus, by deactivating the engine and then moving the operator heat controller to the first position, the operator may supply electrical energy to the electrically-powered coolant pump, which is operably coupled to heat the operator station.

### SUMMARY OF THE INVENTION

In one aspect, the disclosure relates to a method for providing supplementary heat energy into a cabin of a work machine when a main heating system of the cabin is inactive. The method includes using an auxiliary heat source powered by an auxiliary energy form alternate to a main energy form to impart heat to an auxiliary coolant stream. The main energy form powers a main heat source of the main heating system. Further, the method includes providing an auxiliary fluid circuit to fluidly couple the auxiliary heat source with one or more heat exchangers to supply the auxiliary coolant stream from the auxiliary heat source to the one or more heat exchangers for circulation therewithin. During the circulation of the auxiliary coolant stream within the one or more heat exchangers, the auxiliary coolant stream dissipates heat to an air flowing across the one or more heat exchangers and into the cabin to provide the supplementary heat energy into the cabin.

In another aspect, the disclosure is directed to a heating arrangement for a cabin of a work machine. The heating arrangement includes one or more heat exchangers, a main heating system, and an auxiliary heating system. The main heating system includes a main heat source and a main fluid circuit. The main heat source is powered by a main energy form to impart heat to a main coolant stream. The main fluid circuit is fluidly coupled between the main heat source and the one or more heat exchangers to supply the main coolant stream from the main heat source to the one or more heat exchangers for circulation therewithin. The main coolant stream dissipates heat to an air flowing across the one or more heat exchangers and into the cabin to provide main heat energy into the cabin. The auxiliary heating system includes an auxiliary heat source and an auxiliary fluid circuit. The auxiliary heat source is powered by an auxiliary energy form alternate to the main energy form. The auxiliary heat source is configured to impart heat to an auxiliary coolant stream different from the main coolant stream. The auxiliary fluid circuit is fluidly coupled between the auxiliary heat source with the one or more heat exchangers to supply the auxiliary coolant stream from the auxiliary heat source to the one or more heat exchangers for circulation therewithin. During the circulation of the auxiliary coolant stream within the one or more heat exchangers, the auxiliary coolant stream dissipates heat to the air blowing across the one or more heat exchangers and into the cabin to provide supplementary heat energy into the cabin.

In yet another aspect, the disclosure relates to a work machine. The work machine includes a main frame, a cabin, and a heating arrangement for the cabin. The cabin is supported on the main frame. The cabin is configured to station one or more operators therewithin. The heating arrangement includes one or more heat exchangers, a main heating system, and an auxiliary heating system. The main heating system includes a main heat source and a main fluid circuit. The main heat source is powered by a main energy form to impart heat to a main coolant stream. The main fluid circuit is fluidly coupled between the main heat source and the one or more heat exchangers to supply the main coolant stream from the main heat source to the one or more heat exchangers for circulation therewithin. The main coolant stream dissipates heat to an air flowing across the one or more heat exchangers and into the cabin to provide main heat energy into the cabin. The auxiliary heating system includes an auxiliary heat source and an auxiliary fluid circuit. The auxiliary heat source is powered by an auxiliary energy form alternate to the main energy form. The auxiliary heat source is configured to impart heat to an auxiliary coolant stream different from the main coolant stream. The auxiliary fluid circuit is fluidly coupled between the auxiliary heat source with the one or more heat exchangers to supply the auxiliary coolant stream from the auxiliary heat source to the one or more heat exchangers for circulation therewithin. During the circulation of the auxiliary coolant stream within the one or more heat exchangers, the auxiliary coolant stream dissipates heat to the air blowing across the one or more heat exchangers and into the cabin to provide supplementary heat energy into the cabin.

### BRIEF DESCRIPTION OF THE DRAWINGS

FIG. 1 illustrates an exemplary work machine provided with a cabin, in accordance with an embodiment of the present disclosure;

FIG. 2 illustrates a heating arrangement for providing heat energy to the cabin, in accordance with an embodiment of the present disclosure;

FIG. 3 illustrates a heating arrangement for providing heat energy to the cabin, in accordance with another embodiment of the present disclosure;

FIG. 4 illustrates a heating arrangement for providing heat energy to the cabin, in accordance with yet another embodiment of the present disclosure; and

FIG. 5 illustrates a flowchart illustrating a method for providing supplementary heat energy into the cabin, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

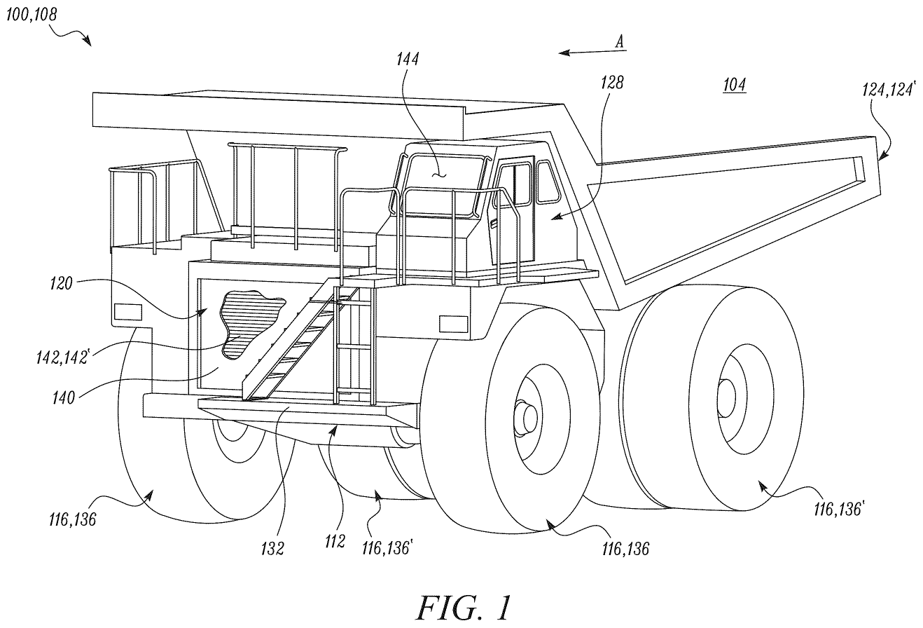

Referring to FIG. 1, an exemplary work machine 100 (hereinafter referred to as “machine 100”) is shown. The machine 100 may perform a variety of tasks associated with an industry such as construction, mining, farming, transportation, or any other industry known in the art. As an example, the machine 100 may be configured to receive payload from a load location of a worksite 104, traverse in a forward direction (indicated by an arrow ‘A’) from the load location toward a dump location of the worksite 104, release and dump the payload at the dump location, and traverse back toward the load location. Examples of the worksite 104 may include, but not limited to, a construction site, a surface mine site, a landfill, a quarry, an underground mine site, etc.

In one exemplary embodiment of the present disclosure, the machine 100 includes a large mining truck 108, which is commonly employed and operated at surface mine sites for the transfer and/or delivery of materials, such as ores and minerals. However, aspects of the present disclosure may be applied to several other machines. For example, aspects of the present disclosure also may be applicable to various other mobile machines which may include one or more cabins. Examples of such machines may include construction machines and/or mining machines, such as loaders, excavators, shovels, graders, scrapers, mining trucks, off-highway trucks, and/or the like. Therefore, it will be appreciated that references to the machine 100 (e.g., the large mining truck 108) is purely exemplary.

The machine 100 includes a main frame 112, one or more traction assemblies 116, a power source 120, an implement 124, and a cabin 128. The main frame 112 may accommodate and/or support the power source 120, the implement 124 (e.g., a dump body 124′), and the cabin 128, although other known components and structures of the machine 100 may be supported by the main frame 112, as well. In an example, the main frame 112 defines a front portion 132 and a rear portion (not shown). The front portion 132 may accommodate/support the cabin 128 and the power source 120, whereas the rear portion may support the dump body 124′ of the machine 100.

The traction assemblies 116 may support the machine 100 in a loaded, partially loaded, and empty condition, so that a desired amount of traction and/or cushioning is provided, regardless of the payload present on the machine 100. In an example, as shown in FIG. 1, the traction assemblies 116 include a set of front wheels 136 and a set of rear wheels 136′. In other embodiments, the traction assemblies 116 may include crawler tracks (not shown) provided either alone or in combination with the wheels 136, 136′.

The power source 120 may include a power compartment 140 and a prime mover 142 provided within the power compartment 140. The prime mover may include an internal combustion engine 142′, such as a diesel engine, a gasoline engine, a gaseous fuel powered engine (e.g., a natural gas engine), or any other type of combustion engine known in the art. The prime mover 142 may alternatively include a non-combustion source of power, such as a fuel cell, or a power storage device, such as a battery unit. The prime mover 142 may be configured to generate an output power required to operate various systems on the machine 100, such as the traction assemblies 116.

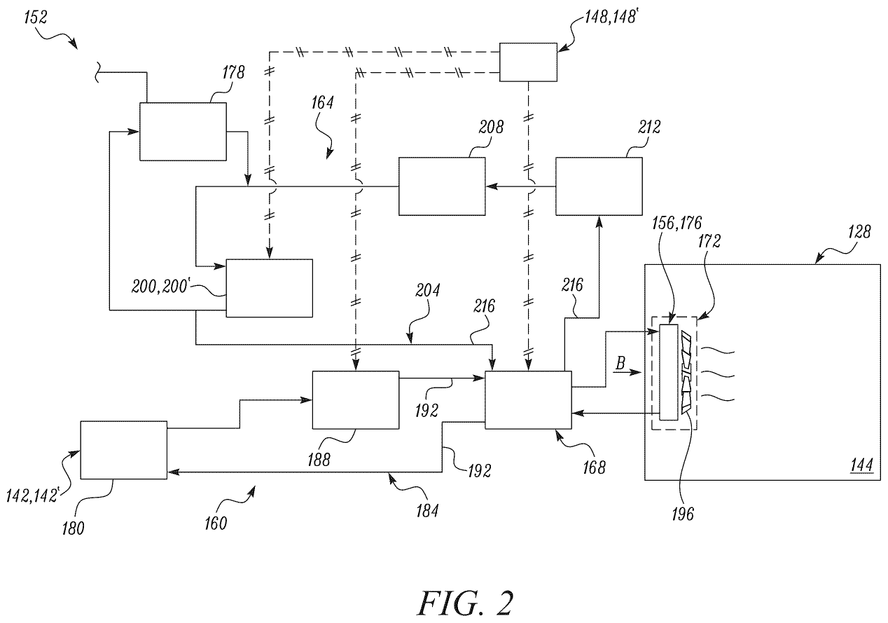

The cabin 128 is supported on the main frame 112. In an example, as shown in FIG. 1, the cabin 128 is supported on the front portion 132 of the main frame 112, although various other locations of the cabin 128 may be contemplated. The cabin 128 may define an interior volume 144 which may house various parts and/or systems, such as controls, etc., of the machine 100. The cabin 128 facilitates stationing of one or more operators (not shown) of the machine 100 therein for the control of one or more functions of the machine 100. The cabin 128 may include an operator interface 148. The operator interface 148 may include, but not limited to, one or more of a display unit, a control panel, a touchscreen, and/or the like, (not shown) that may be accessed by one or more operators of the machine 100 so as to feed input related to a functioning of the machine 100. In the present embodiment, the operator interface 148 includes a control knob 148′ (as shown in FIG. 2).

The machine 100 operates generally under harsh work environment. As an example, the harsh work environment may include extreme cold weather conditions, such as an ambient temperature of minus 30 degree Celsius or below. To keep one or more operators stationed within the cabin of the machine 100 relatively comfortable in such extreme cold weather conditions, in one or more aspects of the present disclosure, a heating arrangement 152 is disclosed. The heating arrangement 152 includes one or more heat exchangers 156, a main heating system 160, and an auxiliary heating system 164. Also, the heating arrangement 152 includes a flow control valve 168. Each of the heat exchangers 156, the main heating system 160, the auxiliary heating system 164, and the flow control valve 168 will now be discussed in detail with reference to FIG. 2.

The heat exchangers 156 may be associated with an HVAC (Heating Ventilation and Cooling) system 172 of the machine 100. For example, the heat exchangers 156 may be positioned within an enclosure (not shown) (of the HVAC system 172) that may be in fluid communication with the interior volume 144 of the cabin 128. In the present embodiment, as shown in FIG. 2, the heat exchangers 156 include one heat exchanger 156, namely—a heat exchanger 176. The heat exchanger 176 may be a liquid-to-air type heat exchanger. That is, the heat exchanger 176 may facilitate dissipation of heat from, for example, hot coolant stream passing therein to an air blowing across the heat exchanger 176. Examples of the coolant may include, but not limited to, water, glycol, a water/glycol mixture, and oil.

The main heating system 160 is now discussed. The main heating system 160 includes a main heat source 180 and a main fluid circuit 184. The main heat source 180 may include the prime mover 142 (or the internal combustion engine 142′) of the machine 100. The main heat source 180 (or the prime mover 142) is powered by a main energy form, for example, a chemical energy form stored in one or more combustion fuels, such as gasoline, diesel, etc.

The main heat source 180 is configured to impart heat to a main coolant stream passing therethrough. In the present embodiment, the main coolant stream corresponds to an engine coolant stream. The main coolant stream (or the engine coolant stream) may be circulated through the prime mover 142 (or the internal combustion engine 142′), for example, when the prime mover 142 (or the internal combustion engine 142′) is operative to power various functions of the machine 100. During the circulation of the main coolant stream through the operative prime mover 142, the heat may be transferred from the prime mover 142 to the main coolant stream (or the engine coolant stream).

The main fluid circuit 184 is fluidly coupled between the main heat source 180 and the one or more heat exchangers 156 (e.g., the heat exchanger 176). In an example, as shown in FIG. 2, the main fluid circuit 184 may include a number of components, namely—a heater valve 188 that may allow or restrict (for example, upon receipt of a signal from the operator interface 148) a circulation of the main coolant stream in the main fluid circuit 184, and multiple corresponding coolant lines 192 that may route or provide passage to the main coolant stream through the main heat source 180, one or more aforementioned components of the main fluid circuit 184, and the heat exchanger 176.

The main fluid circuit 184 facilitates a supply of the main coolant stream from the main heat source 180 (e.g., the prime mover 142) to the one or more heat exchangers 156 (e.g., the heat exchanger 176, as shown in FIG. 2) for circulation therewithin. During the circulation of the main coolant stream within the heat exchanger 176, the main coolant stream dissipates heat to an air flowing across the heat exchanger 176 and into the interior volume 144 of the cabin 128 to provide main heat energy into the cabin 128. In an example, one or more blowers, such as a blower 196 associated with the HVAC system 172, may direct the air to flow in a direction (indicated by an arrow ‘B’) across the heat exchanger 176 and into the interior volume 144 of the cabin 128.

The auxiliary heating system 164 is now discussed. The auxiliary heating system 164 includes an auxiliary heat source 200 and an auxiliary fluid circuit 204. The auxiliary heat source 200 is different from the main heat source 180. The auxiliary heat source 200 is powered by an auxiliary energy form alternate to (or different from) the main energy form. In the present embodiment, the auxiliary heat source 200 includes an electrical heater 200′ powered by an electrical energy form stored in one or more electrical power sources, such as a battery.

The auxiliary heat source 200 (or the electrical heater 200′) is configured to impart heat to an auxiliary coolant stream passing therethrough. The auxiliary heat source 200 may be activated (e.g., based on an activation signal received from the operator interface 148 or the control knob 148′) to impart heat to the auxiliary coolant stream. In an example, when activated, the auxiliary heat source 200 may receive the auxiliary coolant stream (e.g., from a hydraulic tank 178 of the machine 100) and circulate the auxiliary coolant stream therethrough. During the circulation of the auxiliary coolant stream through the energized auxiliary heat source 200, the heat may be transferred from the auxiliary heat source 200 to the auxiliary coolant stream.

The auxiliary coolant stream is different from the main coolant stream. In an exemplary embodiment, the auxiliary coolant stream and the main coolant stream may be one and same coolant. However, it may be contemplated that in other embodiments, the auxiliary coolant stream and the main coolant stream may be of different coolant types.

The auxiliary fluid circuit 204 is fluidly coupled between the auxiliary heat source 200 and the one or more heat exchangers 156 (e.g., the heat exchanger 176). In an example, as shown in FIG. 2, the auxiliary fluid circuit 204 may include a number of components, namely—an auxiliary hydraulic pump 208, an auxiliary filter 212, and multiple corresponding coolant lines 216. The auxiliary hydraulic pump 208 may circulate the auxiliary coolant stream in the auxiliary fluid circuit 204. The auxiliary filter 212 may remove contaminants from the auxiliary coolant stream passing therethrough. The coolant lines 216 may route or provide passage to the auxiliary coolant stream through the auxiliary heat source 200, one or more aforementioned components of the auxiliary fluid circuit 204, and the heat exchanger 176.

The auxiliary fluid circuit 204 facilitates a supply of the auxiliary coolant stream from the auxiliary heat source 200 (e.g., the electrical heater 200′) to the one or more heat exchangers 156 (e.g., the heat exchanger 176, as shown in FIG. 2) for circulation therewithin. During the circulation of the auxiliary coolant stream within the heat exchanger 156 (or the heat exchanger 176), the auxiliary coolant stream dissipates heat to the air flowing across the heat exchanger 176 and into the interior volume 144 of the cabin 128 to provide supplementary heat energy into the cabin 128.

The flow control valve 168 may be configured to move between a first position and a second position. At the first position, the flow control valve 168 may fluidly couple the main heating system 160 with the one or more heat exchangers 156 (or the heat exchanger 176) and may fluidly decouple the auxiliary heating system 164 with the one or more heat exchangers 156 (or the heat exchanger 176). Accordingly, at the first position, the flow control valve 168 may facilitate the supply of the main coolant stream from the main heat source 180 to the one or more heat exchangers 156 (or the heat exchanger 176) through the main fluid circuit 184 and, may restrict the supply of the auxiliary coolant stream from the auxiliary heat source 200 to the one or more heat exchangers 156 (or the heat exchanger 176) through the auxiliary fluid circuit 204.

At the second position, the flow control valve 168 may fluidly couple the auxiliary heating system 164 with the one or more heat exchangers 156 (or the heat exchanger 176) and may fluidly decouple the main heating system 160 with the one or more heat exchangers 156 (or the heat exchanger 176). Accordingly, at the second position, the flow control valve 168 may facilitate the supply of the auxiliary coolant stream from the auxiliary heat source 200 to the one or more heat exchangers 156 (or the heat exchanger 176) through the auxiliary fluid circuit 204 and, may restrict the supply of the main coolant stream from the main heat source 180 to the one or more heat exchangers 156 (or the heat exchanger 176) through the main fluid circuit 184.

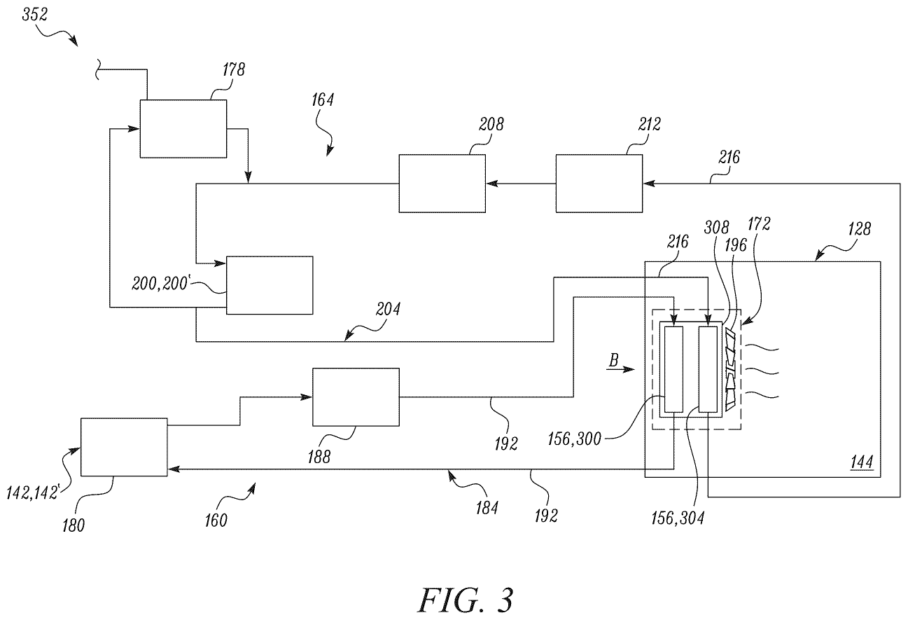

Referring to FIG. 3, a heating arrangement 352 is shown. The heating arrangement 352 is similar to the heating arrangement 152 but may differ from the heating arrangement 152 in that the flow control valve 168 is omitted. Rather, the heating arrangement 352 includes two separate heat exchangers 156, namely—a main heat exchanger 300 and an auxiliary heat exchanger 304. The main heat exchanger 300 and the auxiliary heat exchanger 304 may have constructions and configurations similar to the heat exchanger 176. The main heat exchanger 300 may be configured to be fluidly coupled to the main fluid circuit 184 to receive the supply of the main coolant stream from the main fluid circuit 184. The auxiliary heat exchanger 304 may be configured to be fluidly coupled to the auxiliary fluid circuit 204 to receive the supply of the auxiliary coolant stream from the auxiliary fluid circuit 204.

In an example, the main heat exchanger 300 and the auxiliary heat exchanger 304 may be arranged serially with respect to each other. In so doing, the air flow directed from the blower 196 may sequentially pass through each of the main heat exchanger 300 and the auxiliary heat exchanger 304. In an example, the main heat exchanger 300 is arranged upstream of the auxiliary heat exchanger 304 along the direction ‘B’ of the air flow generated by the blower 196. Such upstream positioning of the main heat exchanger 300 with respect to the auxiliary heat exchanger 304 may be applicable in exemplary cases where the main heat exchanger 300 has a higher heating capacity than the auxiliary heat exchanger 304. In particular, the upstream positioning of the main heat exchanger 300 with respect to the auxiliary heat exchanger 304 may ensure that a relatively higher capacity main heat exchanger 300 may still allow a sufficiently heated air flow to pass through a relatively lower capacity auxiliary heat exchanger 304, positioned downstream, and then into the interior volume 144 of the cabin 128 even when the auxiliary heating system 164 is inactive and when no auxiliary coolant stream is circulated through the auxiliary heat exchanger 304. In other words, the passage of heated air flow may occur from the main heat exchanger 300 into the interior volume 144 of the cabin 128 without substantial heat loss to the auxiliary heat exchanger 304.

It may be noted that the main heat exchanger 300 and the auxiliary heat exchanger 304 may belong to the main heating system 160 and the auxiliary heating system 164, respectively, but may be disposed within a common confinement or structure (e.g., see a confinement 308 associated with the HVAC system 172 of the machine 100) so as to be space efficient within the limited confines of the interior volume 144 of the cabin 128. Also, it will be appreciated that a receipt of the main coolant stream into the main heat exchanger 300 to facilitate the heat dissipation from the main coolant stream to air and a receipt of the auxiliary coolant stream into the auxiliary heat exchanger 304 to facilitate the heat dissipation from the auxiliary coolant stream to air can occur either independently of each other or simultaneously with each other for the supply of heated air flow into the interior volume 144 of the cabin 128 to heat said interior volume 144 of the cabin 128.

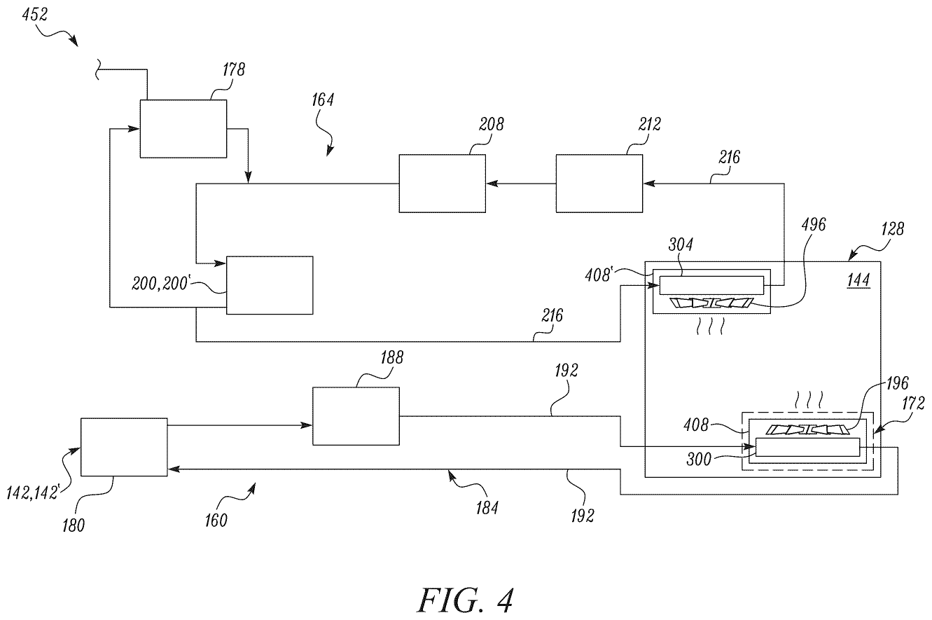

Referring to FIG. 4, a heating arrangement 452 is shown. The heating arrangement 452 is similar to the heating arrangement 352 but may differ from the heating arrangement 352 in that the main heat exchanger 300 and the auxiliary heat exchanger 304 are positioned at two distinct locations within the interior volume 144 of the cabin 128. For example, as shown in FIG. 4, the main heat exchanger 300 may be positioned within a confinement 408 of the HVAC system 172 located at a first location within the interior volume 144 of the cabin 128, whereas the auxiliary heat exchanger 304 (along with a blower 496 different from the blower 196) may be positioned within a confinement 408′ located at a second location (within the interior volume 144 of the cabin 128) different from the first location. In this configuration, the main heat exchanger 300 and the auxiliary heat exchanger 304 (located at two distinct locations within the interior volume 144 of the cabin 128) may operate simultaneously to enhance the amount of heated air supply into the entire interior volume 144 of the cabin 128 for faster heating of the cabin 128.

In some embodiments, the heating arrangement 152 may also include one or more evaporators (not shown) configured to receive one or more coolant streams (different from the main coolant stream and the auxiliary coolant stream) from one or more cooling circuits to cool the air flow passing therethrough. As an example, such cooling may be carried out in an inactive state of each of the main heating system 160 and the auxiliary heating system 164.

### INDUSTRIAL APPLICABILITY

With regard to a working of the main heating system 160, the (hot) main coolant stream from the main heat source 180 (e.g., the prime mover 142 or the internal combustion engine 142′) is supplied to the heat exchanger 176 (via the main fluid circuit 184) and circulated through the heat exchanger 176. At this stage, the flow control valve 168 is at the first position to fluidly couple the main heating system 160 with the heat exchanger 176 (to allow the main coolant stream to circulate through the heat exchanger 176), and to fluidly decouple the auxiliary heating system 164 with the heat exchanger 176 (to restrict the auxiliary coolant stream to circulate through the heat exchanger 176). During the circulation of the main coolant stream through the heat exchanger 176, the main coolant stream dissipates heat to the air flowing (e.g., via the blower 196) across the heat exchanger 176 and into the interior volume 144 of the cabin 128 to provide the main heat energy into the cabin 128. Accordingly, a temperature within the interior volume 144 of the cabin 128 may be raised and hence, the cabin 128 is heated.

In situations in which the main heat source 180 (e.g., the prime mover 142 or the internal combustion engine 142′) is in inoperative state, the main heating system 160 may become inactive or inefficient to supply the main heat energy into the interior volume 144 of the cabin 128. In an example scenario, during an exemplary work cycle of the machine 100 at the worksite 104, if the machine 100 were to receive the payload into the dump body 124′, the machine 100 may be positioned stationarily or retained immobile for a period on the ground surface (e.g., at a load location) to receive an influx of the payload. During such a period, if it is desired that the prime mover 142 (or the internal combustion engine 142′) be switched to the inoperative state, e.g., to prevent idling, reduce engine emissions, and/or mitigate fuel consumption, the main heating system 160 may become inactive as well for that period. To provide the supplementary heat energy into the interior volume 144 of the cabin 128 during this period (i.e., when the main heating system 160 is inactive), the auxiliary heating system 164 is provided.

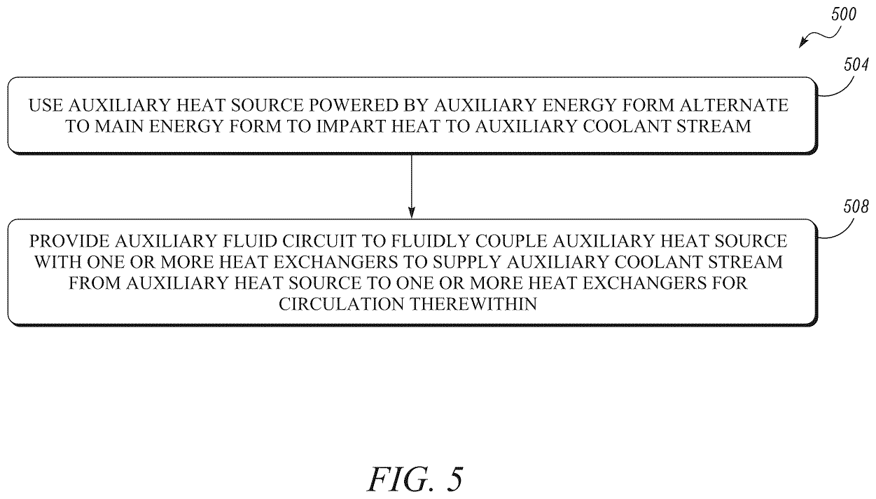

Referring to FIG. 5, an exemplary method for providing the supplementary heat energy into the interior volume 144 of the cabin by using the auxiliary heating system 164 (when the main heating system 160 is inactive) is discussed. The method is discussed by way of a flowchart 500 that illustrates exemplary steps (i.e., 504 and 508) associated with the exemplary method. The method is also discussed in conjunction with FIGS. 1 and 2.

The auxiliary heat source 200 (e.g., the electrical heater 200′) is used to impart heat to the auxiliary coolant stream, at 504. For that, the auxiliary heat source 200 (or the electrical heater 200′) may be powered by the electrical energy form (stored in one or more electrical power sources, such as a battery). In an example, the auxiliary heat source 200 (or the electrical heater 200′) may be powered based on the activation signal received from the operator interface 148 (or the control knob 148′) that may be actuated, for example, manually, by an operator of the machine 100. In addition, the auxiliary fluid circuit 204 is provided to fluidly couple the auxiliary heat source 200 (or the electrical heater 200′) with the one or more heat exchangers 156 (e.g., the heat exchanger 176) to facilitate the supply of the auxiliary coolant stream from the auxiliary heat source 200 (or the electrical heater 200′) to the heat exchanger 176 for circulation therewithin, at 508.

Upon activation of the auxiliary heat source 200 (or the electrical heater 200′), the flow control valve 168 may move (from the first position) to the second position. At the second position, the flow control valve 168 may fluidly couple the auxiliary heating system 164 with the heat exchanger 176 to allow the auxiliary coolant stream to circulate through the heat exchanger 176, and may fluidly decouple the main heating system 160 with the heat exchanger 176 to restrict the main coolant stream to circulate through the heat exchanger 176.

In so doing, the (hot) auxiliary coolant stream from the auxiliary heat source 200 (or the electrical heater 200′) is supplied to the heat exchanger 176 (via the auxiliary fluid circuit 204) and circulated through the heat exchanger 176. During the circulation of the (hot) auxiliary coolant stream through the heat exchanger 176, the auxiliary coolant stream dissipates heat to the air flowing (e.g., via the blower 196) across the heat exchanger 176 and into the interior volume 144 of the cabin 128 to provide the supplementary heat energy into the cabin 128. Accordingly, a temperature within the interior volume 144 of the cabin 128 may be raised and hence, the cabin 128 is heated.

At the lapse of the period and/or once the main heat source 180 (i.e., the prime mover 142 or the internal combustion engine 142′) is switched to the operative state, the operator interface 148 (or the control knob 148′) may be actuated (e.g., by the operator) in a manner to set the auxiliary heat source to the inactive state. At this stage, the flow control valve 168 may move (from the second position) to the first position to fluidly couple the main heating system 160 with the heat exchanger 176 to allow the main coolant stream to circulate through the heat exchanger 176, and to fluidly decouple the auxiliary heating system 164 with the heat exchanger 176 to restrict the auxiliary coolant stream to circulate through the heat exchanger 176.

Although the above description discusses separate or independent operations of the main heating system 160 and the auxiliary heating system 164, in some exemplary embodiments, for example, as shown in FIGS. 3 and 4, the main heating system 160 and the auxiliary heating system 164 may also operate together or simultaneously with each other. In these exemplary embodiments, the main heating system 160 may be in fluid communication with the main heat exchanger 300 to circulate the main coolant stream through the main heat exchanger 300 to provide the main heat energy into the cabin 128, and the auxiliary heating system 164 may be in fluid communication with the auxiliary heat exchanger 304 to circulate the auxiliary coolant stream through the auxiliary heat exchanger 304 to provide the supplementary heat energy into the cabin 128.

The heating arrangement 152, 352, 452 provides heat to the interior volume 144 of the cabin 128 of the machine 100 even when one of the heating system (e.g., the main heating system 160) is inactive. In effect, one heating system of the heating arrangement 152, 352, 452 serves as back-up for the other heating system of the heating arrangement 152, 352, 452. This may enhance and/or retain operator comfort across multiple stages of work cycles of the machine 100 at the worksite 104. Further, integration of the main heating system 160 and the auxiliary heating system 164 with the one or more heat exchangers 156 of one or more existing HVAC systems (e.g., the HVAC system 172) of the machine 100 may allow the heating arrangement 152, 352, 452 to be space efficient within the already limited confines of the interior volume 144 of the cabin 128.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system, the work machine, and/or the method of the present disclosure without departing from the scope of the disclosure. Other embodiments will be apparent to those skilled in the art from consideration of the specification and practice of the system, the work machine, and/or the method disclosed herein. It is intended that the specification and examples be considered as exemplary only, with a true scope of the disclosure being indicated by the following claims and their equivalent.

1. A method for providing supplementary heat energy into a cabin of a work machine when a main heating system of the cabin is inactive, the method comprising:
using an auxiliary heat source powered by an auxiliary energy form alternate to a main energy form to impart heat to an auxiliary coolant stream, the main energy form powering a main heat source of the main heating system; and
providing an auxiliary fluid circuit to fluidly couple the auxiliary heat source with one or more heat exchangers to supply the auxiliary coolant stream from the auxiliary heat source to the one or more heat exchangers for circulation therewithin,
wherein, during the circulation of the auxiliary coolant stream within the one or more heat exchangers, the auxiliary coolant stream dissipates heat to an air flowing across the one or more heat exchangers and into the cabin to provide the supplementary heat energy into the cabin.

2. The method of claim 1, wherein the main heating system includes a main fluid circuit for supplying a main coolant stream from the main heat source to the one or more heat exchangers for circulation therewithin, the method further including:
providing a flow control valve configured to move between a first position and a second position, wherein:
at the first position, the flow control valve restricts the supply of the auxiliary coolant stream from the auxiliary heat source to the one or more heat exchangers through the auxiliary fluid circuit and facilitates the supply of the main coolant stream from the main heat source to the one or more heat exchangers through the main fluid circuit, and at the second position, the flow control valve restricts the supply of the main coolant stream from the main heat source to the one or more heat exchangers through the main fluid circuit and facilitates the supply of the auxiliary coolant stream from the auxiliary heat source to the one or more heat exchangers through the auxiliary fluid circuit.

3. The method of claim 2, wherein the main coolant stream and the auxiliary coolant stream are one and same coolant.

4. The method of claim 2, wherein the flow control valve is moved from the first position to the second position upon activation of the auxiliary heat source.

5. The method of claim 1, wherein:
the main heating system includes a main fluid circuit for supplying a main coolant stream from the main heat source to the one or more heat exchangers for circulation therewithin, and
the one or more heat exchangers include a main heat exchanger configured to be fluidly coupled to the main fluid circuit to receive the supply of the main coolant stream from the main fluid circuit and an auxiliary heat exchanger configured to be fluidly coupled to the auxiliary fluid circuit to receive the supply of the auxiliary coolant stream from the auxiliary fluid circuit.

6. The method of claim 5 further including serially arranging the main heat exchanger and the auxiliary heat exchanger with respect to each other to allow the air to flow across each of the main heat exchanger and the auxiliary heat exchanger, wherein the main heat exchanger is arranged upstream of the auxiliary heat exchanger with respect to a direction of the air flowing into the cabin.

7. The method of claim 1, wherein the auxiliary energy form includes an electrical energy form stored in one or more electrical power sources and the main energy form includes a chemical energy form stored in one or more combustion fuels.

8. A heating arrangement for a cabin of a work machine, the heating arrangement comprising:
one or more heat exchangers;
a main heating system including:
a main heat source powered by a main energy form to impart heat to a main coolant stream; and
a main fluid circuit fluidly coupled between the main heat source and the one or more heat exchangers to supply the main coolant stream from the main heat source to the one or more heat exchangers for circulation therewithin such that the main coolant stream dissipates heat to an air flowing across the one or more heat exchangers and into the cabin to provide main heat energy into the cabin; and
an auxiliary heating system including:
an auxiliary heat source powered by an auxiliary energy form alternate to the main energy form, the auxiliary heat source configured to impart heat to an auxiliary coolant stream different from the main coolant stream; and
an auxiliary fluid circuit fluidly coupled between the auxiliary heat source with the one or more heat exchangers to supply the auxiliary coolant stream from the auxiliary heat source to the one or more heat exchangers for circulation therewithin,
wherein, during the circulation of the auxiliary coolant stream within the one or more heat exchangers, the auxiliary coolant stream dissipates heat to the air blowing across the one or more heat exchangers and into the cabin to provide supplementary heat energy into the cabin.

9. The heating arrangement of claim 8, wherein the main coolant stream and the auxiliary coolant stream are one and same coolant.

10. The heating arrangement of claim 8 further including a flow control valve configured to move between a first position and a second position, wherein: at the first position, the flow control valve restricts the supply of the auxiliary coolant stream from the auxiliary heat source to the one or more heat exchangers through the auxiliary fluid circuit and facilitates the supply of the main coolant stream from the main heat source to the one or more heat exchangers through the main fluid circuit, and at the second position, the flow control valve restricts the supply of the main coolant stream from the main heat source to the one or more heat exchangers through the main fluid circuit and facilitates the supply of the auxiliary coolant stream from the auxiliary heat source to the one or more heat exchangers through the auxiliary fluid circuit.

11. The heating arrangement of claim 10, wherein the flow control valve is moved from the first position to the second position upon activation of the auxiliary heat source.

12. The heating arrangement of claim 8, wherein the one or more heat exchangers include a main heat exchanger configured to be fluidly coupled to the main fluid circuit to receive the supply of the main coolant stream from the main fluid circuit and an auxiliary heat exchanger configured to be fluidly coupled to the auxiliary fluid circuit to receive the supply of the auxiliary coolant stream from the auxiliary fluid circuit.

13. The heating arrangement of claim 12, wherein the main heat exchanger and the auxiliary heat exchanger are serially arranged with respect to each other to allow the air to flow across each of the main heat exchanger and the auxiliary heat exchanger, the main heat exchanger is arranged upstream of the auxiliary heat exchanger with respect to a direction of the air flowing into the cabin.

14. The heating arrangement of claim 8, wherein the auxiliary energy form includes an electrical energy form stored in one or more electrical power sources and the main energy form includes a chemical energy form stored in one or more combustion fuels.

15. A work machine, comprising:
a main frame;
a cabin supported on the main frame and configured to station one or more operators therein;
a heating arrangement for the cabin, the heating arrangement including:
one or more heat exchangers;
a main heating system including:
a main heat source powered by a main energy form to impart heat to a main coolant stream; and
a main fluid circuit fluidly coupled between the main heat source and the one or more heat exchangers to supply the main coolant stream from the main heat source to the one or more heat exchangers for circulation therewithin such that the main coolant stream dissipates heat to an air flowing across the one or more heat exchangers and into the cabin to provide main heat energy into the cabin; and
an auxiliary heating system including:
an auxiliary heat source powered by an auxiliary energy form alternate to the main energy form, the auxiliary heat source configured to impart heat to an auxiliary coolant stream different from the main coolant stream; and
an auxiliary fluid circuit fluidly coupled between the auxiliary heat source with the one or more heat exchangers to supply the auxiliary coolant stream from the auxiliary heat source to the one or more heat exchangers for circulation therewithin,
wherein, during the circulation of the auxiliary coolant stream within the one or more heat exchangers, the auxiliary coolant stream dissipates heat to the air blowing across the one or more heat exchangers and into the cabin to provide supplementary heat energy into the cabin.

16. The work machine of claim 15, wherein the main coolant stream and the auxiliary coolant stream are one and same coolant.

17. The work machine of claim 15, wherein the heating arrangement includes a flow control valve configured to move between a first position and a second position, wherein:
at the first position, the flow control valve restricts the supply of the auxiliary coolant stream from the auxiliary heat source to the one or more heat exchangers through the auxiliary fluid circuit and facilitates the supply of the main coolant stream from the main heat source to the one or more heat exchangers through the main fluid circuit, at the second position, the flow control valve restricts the supply of the main coolant stream from the main heat source to the one or more heat exchangers through the main fluid circuit and facilitates the supply of the auxiliary coolant stream from the auxiliary heat source to the one or more heat exchangers through the auxiliary fluid circuit, and the flow control valve is moved from the first position to the second position upon activation of the auxiliary heat source.

18. The work machine of claim 15, wherein the one or more heat exchangers include a main heat exchanger configured to be fluidly coupled to the main fluid circuit to receive the supply of the main coolant stream from the main fluid circuit and an auxiliary heat exchanger configured to be fluidly coupled to the auxiliary fluid circuit to receive the supply of the auxiliary coolant stream from the auxiliary fluid circuit.

19. The work machine of claim 18, wherein the main heat exchanger and the auxiliary heat exchanger are serially arranged with respect to each other to allow the air to flow across each of the main heat exchanger and the auxiliary heat exchanger, the main heat exchanger is arranged upstream of the auxiliary heat exchanger with respect to a direction of the air flowing into the cabin.

20. The work machine of claim 15, wherein the auxiliary energy form includes an electrical energy form stored in one or more electrical power sources and the main energy form includes a chemical energy form stored in one or more combustion fuels.
